(19) United States
(12) Patent Application Publication
(10) Pub. No.: US 2013/0006705 A1
(43) Pub. Date: Jan. 3, 2013

(54) Small business intelligence tool

(75) Inventors: Elizabeth S. Votaw, Potomac, MD (US); Charles D. Andrews, Huntersville, NC (US); Charles W. Reed, New York, NY (US); Aaron R. Leinker, Charlotte, NC (US)

(73) Assignee: Bank of America, Charlotte, NC (US)

(21) Appl. No.: 13/200,279

(22) Filed: Sep. 22, 2011

Related U.S. Application Data
(60) Provisional application No. 61/503,532, filed on Jun. 30, 2011.

(51) Int. Cl. G06Q 30/02

(52) U.S. Cl. 705/7.29

(57) ABSTRACT

Aspects of the disclosure relate to systems and methods for electronically displaying an indication of customer spending associated with a pre-determined business location. The method includes using a receiver to receive an electronic request. The request authorizes retrieval of customer spend information associated with the location. The customer spend information may be based on customer credit, debit and/or check transactions. The customer spend information includes a plurality of customer spend data points. The method further includes using the receiver to receive an electronic selection of a limitation of the distance from the pre-determined business location. The limitation may limit the retrieval of customer spend information to a radius corresponding to the limitation.

### CROSS-REFERENCE TO RELATED APPLICATION

This application is a non-provisional application of U.S. Provisional Application No. 61/503,532, filed Jun. 30, 2011, entitled, “SMALL BUSINESS INTELLIGENCE TOOL.”

### FIELD OF TECHNOLOGY

Aspects of the disclosure relate to business intelligence.

### BACKGROUND

It is often important for a business to know the location of its customer base. It is also important for a business to know the location of the business' competitor's customer base. Such information may allow a business to more efficiently target advertising campaigns, coupon mailings, etc.

Such customer information may also help a business select a new location and/or move operations.

It would be desirable for a business to have reliable access to the geographic distribution of its customer base.

It would be desirable as well for a business to have reliable access to the geographic distribution of its competitor(s) customer base.

It is an object of this invention to provide reliable access to the geographic distribution of its customer base.

It is a further object of this invention to provide reliable access to the geographic distribution of a business' competitor's customer base.

### SUMMARY OF THE DISCLOSURE

A method for electronically displaying an indication of customer and/or competitor spending associated with a pre-determined business location is provided. The method preferably includes using a receiver to receive an electronic request. The request preferably authorizes retrieval of customer spend information associated with the location. The customer spend information is preferably based on customer credit, debit and/or check transactions. The customer spend information includes a plurality of competitor spend data points. The method further includes using the receiver to receive the customer spend information and using a processor to display a plurality of visual indicators corresponding to the customer spend information. Each of the visual indicators corresponds to a threshold amount of competitor spend data points located in an area within a pre-defined distance of the visual indicator.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows apparatus that may be used in accordance with the principles of the invention;

FIG. 2 shows a Graphical User Interface (“GUI”) according to the principles of the invention;

FIG. 3 shows the GUI of FIG. 2 with additional features according to the principles of the invention;

FIG. 4 shows the GUI of FIG. 3 with additional features according to the principles of the invention;

FIG. 5 shows the GUI of FIG. 4 with additional features according to the principles of the invention;

FIG. 6 shows the GUI of FIG. 5 with additional features according to the principles of the invention;

FIG. 7 shows the GUI of FIG. 6 with additional features according to the principles of the invention;

FIG. 8 shows the GUI of FIG. 7 with additional features according to the principles of the invention;

FIG. 9 shows the GUI of FIG. 8 with additional features according to the principles of the invention; and

FIG. 10 shows the GUI of FIG. 9 with an additional feature according to the principles of the invention.

### DETAILED DESCRIPTION OF THE DISCLOSURE

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

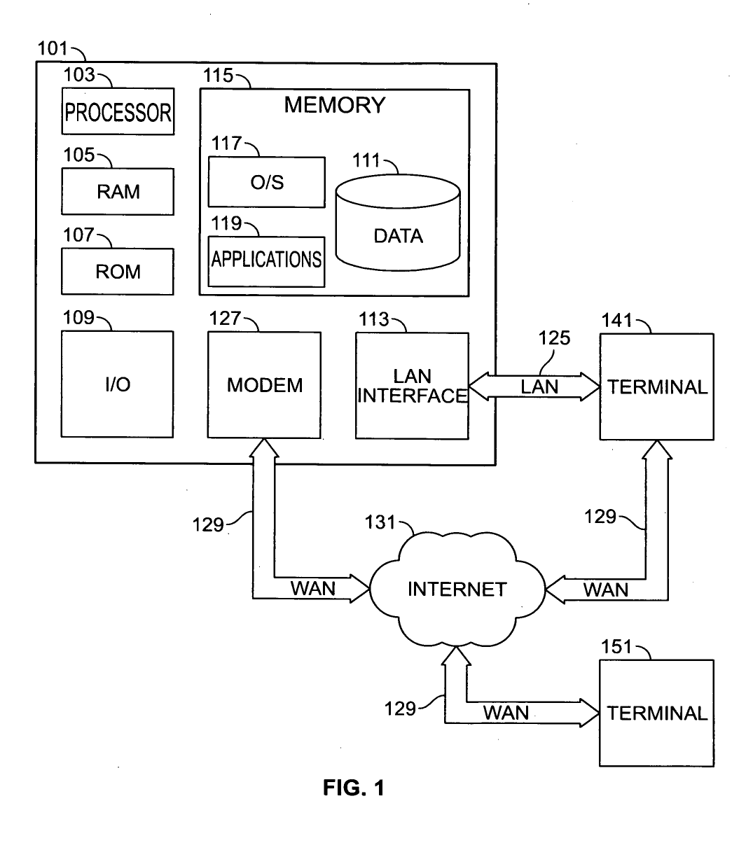

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 125.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 125 and/or storage to provide instructions to processor 103 for enabling server 101 to perform various functions. For example, memory 125 may store software used by server 101, such as an operating system 117, application programs 119, and an associated database 121. Alternatively, some or all of server 101 computer executable instructions may be embodied in hardware or firmware (not shown). As described in detail below, database 121 may provide storage for transaction data, business location information, customer spend information and statistics, and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a smartphone, tablet device, mobile phone, battery, speaker, and antennas (not shown).

Business location information, customer spend information, and any other suitable information, may be retrieved and stored in memory 125.

Systems and methods according to the invention preferably provide small business owners with valuable business intelligence data. All data in the following exemplary embodiments are fictional. Real data for use in systems and methods according to the invention may preferably be derived from existing transaction data. Such transaction data may be obtained based on debit card use, credit card use and/or checks. Such debit card use, credit card use and/or checks may be used to purchase products and services from small businesses.

Information may be obtained from a credit card account via an account access control program. The tool may execute the account access control program and use the account access control program to engage a processor to transmit information to the tool regarding transactions on the credit card account.

In certain embodiments of the invention, the account access control program may operate based on a customer opt-in tool—i.e., the customer may voluntarily select an option presented by the credit card company and/or financial institution which supports the administration of the credit card to obtain access to at least some of the customer's credit card information.

In such embodiments—i.e., where the credit card customers opt-in to disclosure of their respective information, or other embodiments,—the tool may base display of transactions on less than 100% of the transaction data. In fact, because any given financial institution may only support a portion of the customer base of the tool user, the tool should preferably be configured to extrapolate results from a population that is a fraction of the total user customer base. One such extrapolation may be based on the following equation:

Total extrapolated customer spend=ccsd/% mscc*% cbo

Where:
ccsd=credit card spend data
% mscc=percent market share of particular credit card; and
% cbo=percent of customer base that opt-in to share data

Alternatively, the credit card company may, independent of the user's decision, access credit card information for the user. In certain embodiments, the information may be provided anonymously—e.g., the location information of the credit card holder may be provided to an accuracy of one city block—or some other predetermined distance—but not be provided to the exact location of the account holder.

In response to the invocation of the account access control program, the tool may receive transaction information from a payment engine. The transaction information may include information about transactions or attempted transactions on the account. For example, the transaction information may include a transaction date, a transaction payee, a transaction amount and any other suitable transaction information. The payee may be, for example, the tool user or the user's competitor(s).

The tool may use transaction information to tally, preferably over a certain pre-determined time period, the number of transactions, preferably by a predetermined payor, at the selected payee that have occurred. Furthermore, the tool may use the transaction information to sum the value of the transactions, preferably over a pre-determined period of time, at the selected payee.

In some embodiments of the invention, the user of the tool—i.e., the small business owner interested in reviewing the spend information—may authorize the tool to automatically populate transaction information for that specific entity's customer base.

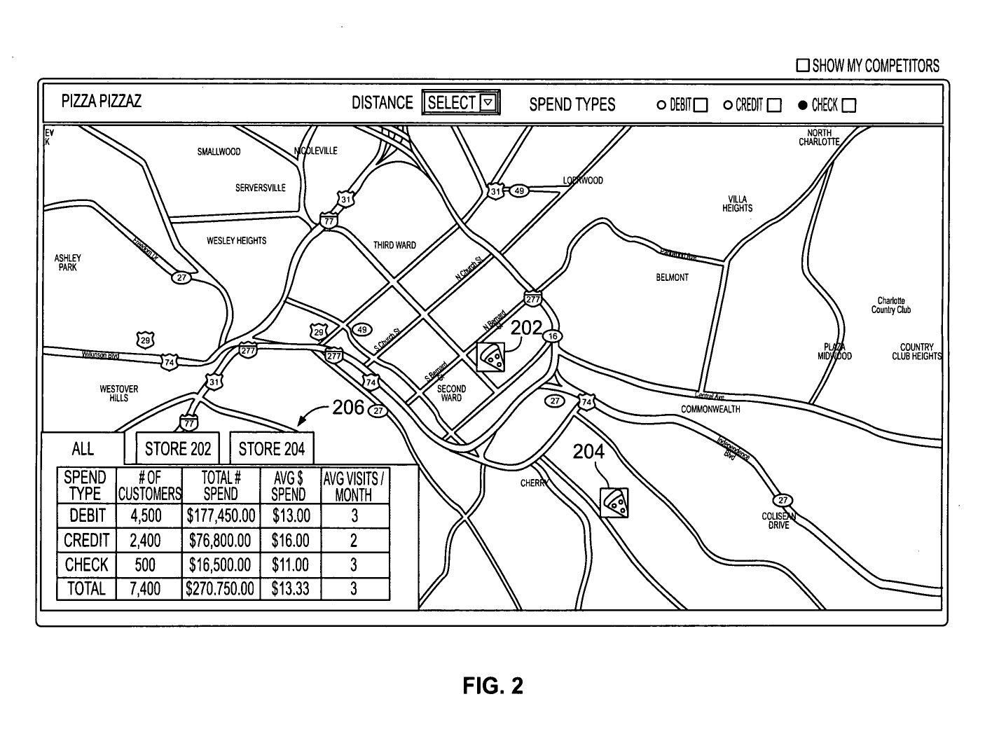

Once the user has authorized the tool via an exemplary log-in process, a graphical user interface (“GUI”) according to the invention presents the user with a geographic representation of the user's business locations. FIG. 2 shows a fictional Pizza Store client that has two locations 202 and 204 in Charlotte, N.C.

Each location is represented by a small pizza slice image and placed in their respective geographic location. In some embodiments of the invention, if the user hovers a pointer device over each location, the GUI identifies the location using a naming structure preferably determined by the user. In this case, stores 202 and 204 are numbered.

The GUI may also display a chart 206 including specific data from transactional history for the user's customers. The GUI combines data from both locations under the ALL tab. The GUI can also separate the data for each store under separate tabs.

In addition to seeing the raw data in the chart, the GUI, according to the invention, can provide the user with a geographic display of where the customers live. The GUI preferably segregates such information according to the customer's spending behavior.

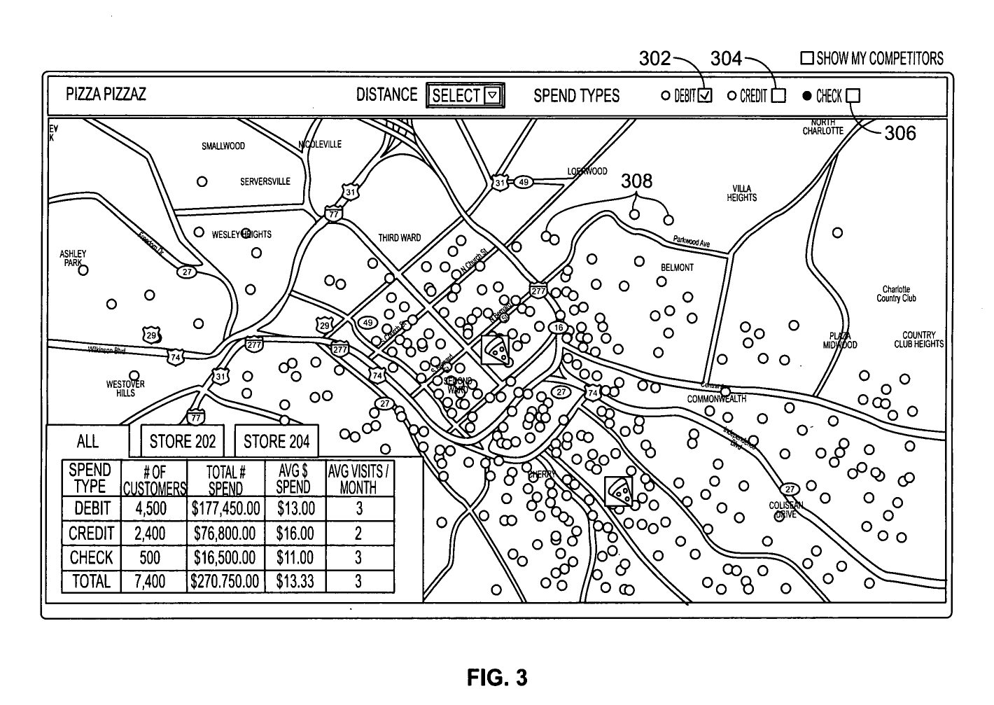

FIG. 3 shows spend type tabs for credit customers 302, debit customers 304 and check customers 306. In certain embodiments of the invention, when the user clicks on debit 302, a first set of dots 308 appear. Said dots correspond to the residences of each of the user's debit customers or to a concentration of a certain number of users.

In such an embodiment of the invention, each of the dots may represent a user concentration of 10 customers within a predetermined radius of the location of the dot. If there are less than 10 customers in a geographic region, a dot will preferably not appear.

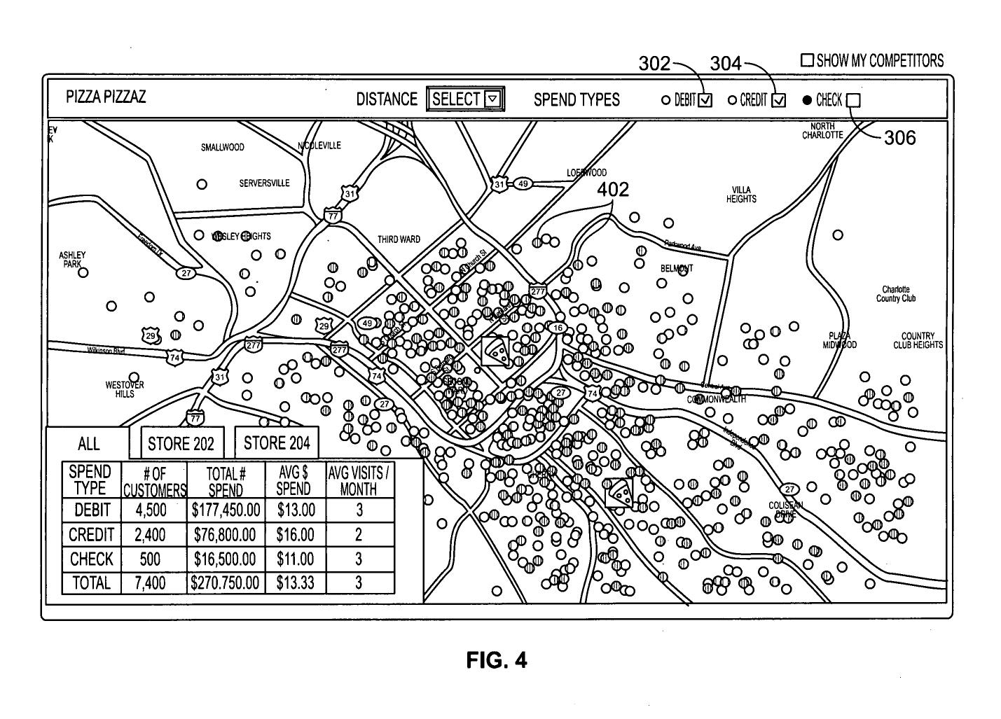

Similarly to the debit data corresponding to tab 302, if a user clicks on the credit tab 304, other dots 402 appear, as shown in FIG. 4. The GUI may differentiate each single set of dots from other sets of dots by illustrating each set of dots using a different color and/or using a different texture. Similar to dots 308, dots 402 may represent a minimum of 10 customers per dot. In FIG. 4, such concentrations indicate that at least 10 customers within a specified radius of the dot used a credit card to make a purchase at either of these store locations.

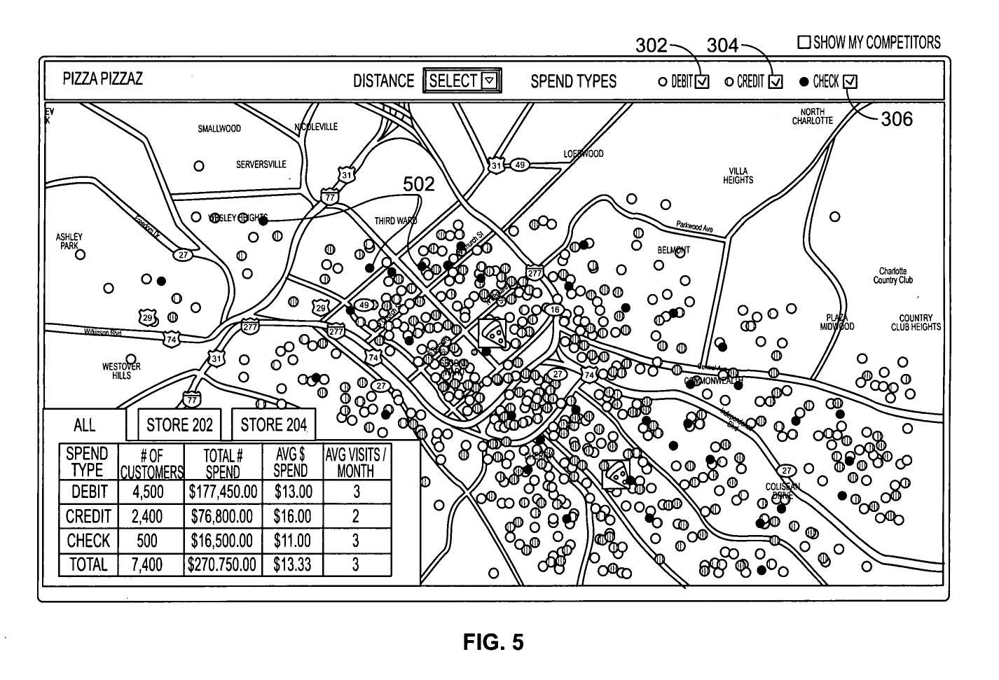

FIG. 5 shows that the GUI displays yet a third set of dots 502 in response to a user selection of check tab 306.

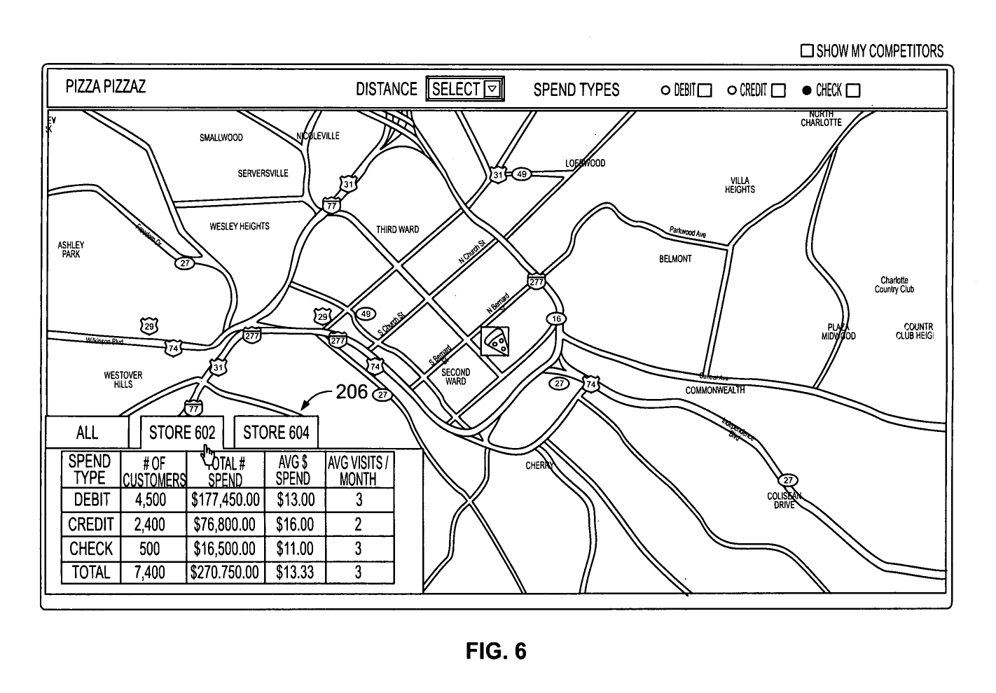

In response to a selection of tab 602, FIG. 6 shows that the GUI may display only data associated with the single location 202. Such a selection may also clear all the data selections—i.e., credit, debit or check tabs—associated with previous displays.

In response to the selection of tab 602, as opposed to tab 604, the GUI preferably displays only location 202. In addition, chart 206 may reflect data only from customers that exclusively frequent location 202.

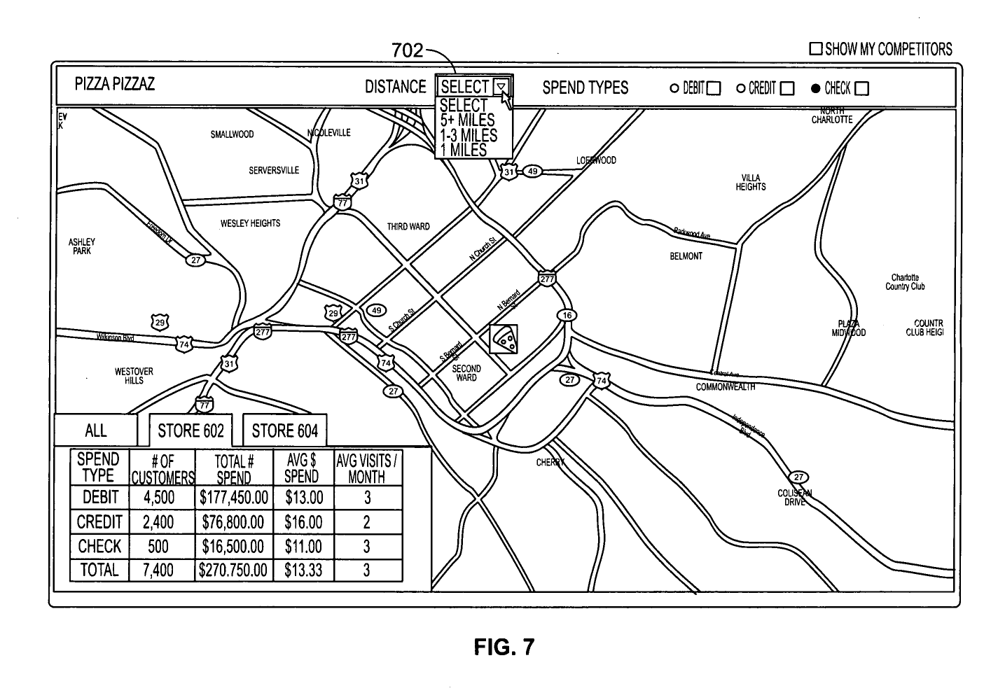

FIG. 7 shows that the GUI also may display geographic data selector 702 in some exemplary embodiments of the invention. Selector 702 may be used to selectively illustrate transaction data associated with location 202. Specifically, selector 702 displays transaction data only within a specific distance of location 202. In certain embodiments, all data may default to a five-mile radius, or other suitable distance, of location 202. When the user selects (or, alternatively, hovers over) selector 702, the GUI presents distance selection choices that may be selected by the user.

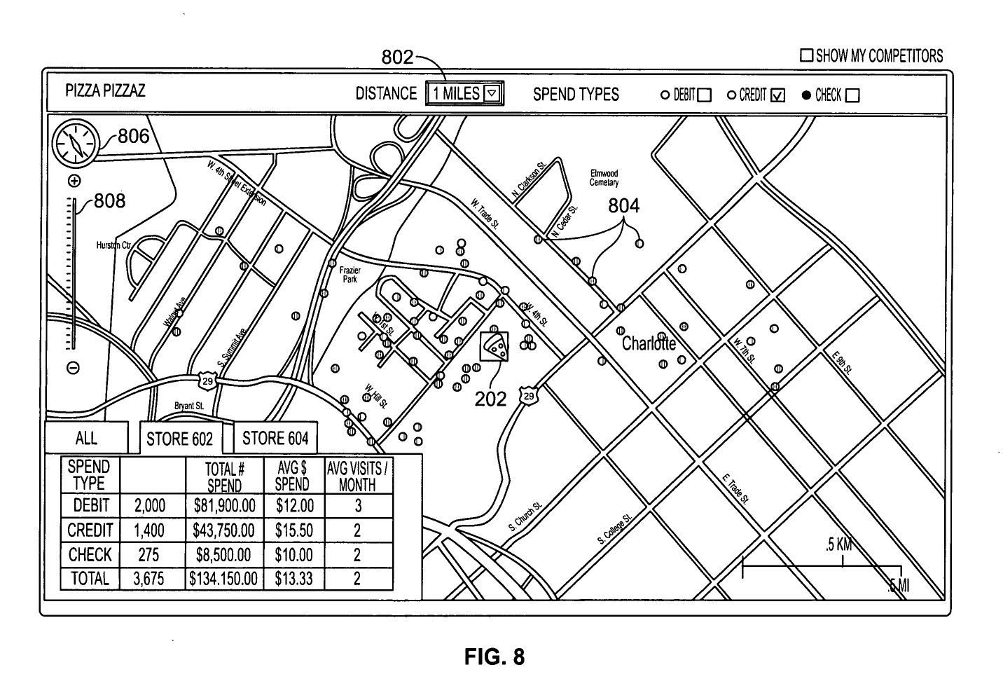

FIG. 8 shows dots 804 associated with check customers that frequent location 202 and reside one mile or less from location 202. FIG. 8 also shows compass 806 and zoom in/zoom out bar 808.

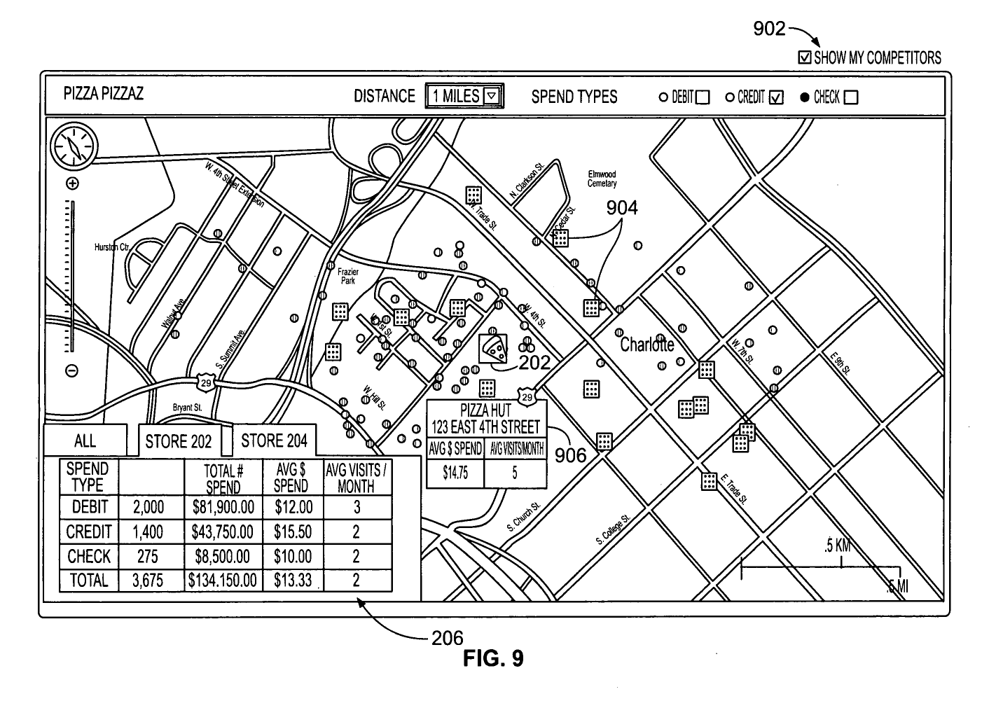

Yet another feature of the invention relates to competitor's information. FIG. 9 shows “show my competitors” selector 902. Such a tool preferably provides a user with information about the user's competitors, shown graphically at 904. In response to a user selection of selector 902, locations 904 of the user's competitors appear. Only locations 904 that are proximal to the user location 202 as well as the location of the user's customers. In certain embodiments of the invention, in response to the user selecting or hovering over a competitor location, the GUI identifies the name, location and some key spend data (as shown in chart 206 and or chart 906) for that competitor locations' customers.

The GUI according to the invention may enable a user to more carefully target customer offers. For example, if the transactional data showed that credit card customers spend more than debit card customers, the user may target your debit card customers only with benefit offers in order to encourage the debit card users to begin using their credit card.

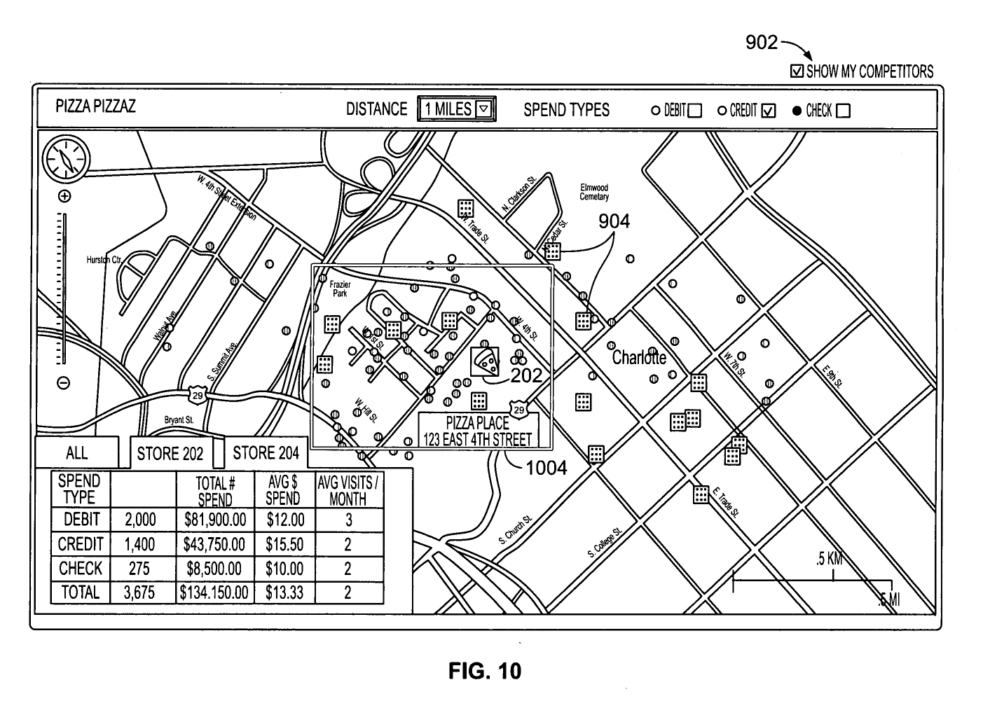

Furthermore, a GUI according to the invention may identify a population of customers and target them directly for marketing and offer campaigns. For example, FIG. 10 shows a preferably user-definable window 1004.

Window 1004 may be used by a user to identify a particular geographic area. Such an area may preferably correspond to one or more zip codes and/or zip code “+four” regional codes. Definition of such an area may be implemented using known geographic information systems.

The tool, according to the invention, may receive a user-defined area and provide the one or more zip codes and/or zip code “+ four” regional codes to the user. In such embodiments, the one or more zip codes and/or zip code “+ four” regional codes may be exported into a computer file such as an Excel® file, whereby the information may be pre-formatted for use in a mass mailing and/or other mass advertising campaign.

Because window 1004 is user-definable, and be implemented as an overlay, the user may preferably overlay window 1004 over some or all of the user's customer base, as displayed on the user interface. In some embodiments, the user may also overlay window 1004 over some or all of the user's competitor's customer base. As such, window 1004 may be used as a directed business tool.

In certain embodiments, a table, similar to the table 904 shown in FIGS. 9 and 10, may be used in tandem with window 1004. The table similar to table 904 may show the value of the customer transactions over a predetermined amount of time. In the alternative, the table may show the value of the user's competitor's transactions over a certain period of time. In such embodiments, window 1004 may preferably be resizable in response to a user input. Accordingly, when the user either resizes and/or moves window 1004, values shown in a table according to the invention may preferably adjust, dependent upon the geographic area circumscribed by the table.

Exemplary equations for determining the density of the value of customer transactions within the area circumscribed by the window (hereinafter, “v(w)”) that correspond to the above-described embodiment may be as follows:

density_{customers}=v(w_{customers})/area (in square miles) circumscribed by window

density_{competitor's customers}=v(w_{competitor's customers})/area (in square miles) circumscribed by window

densityₐₗₗ=v(wₐₗₗ)/area (in square miles) circumscribed by window

The foregoing represents some of the features of systems and methods according to the invention.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Aspects of the invention have been described in terms of illustrative embodiments thereof. A person having ordinary skill in the art will appreciate that numerous additional embodiments, modifications, and variations may exist that remain within the scope and spirit of the invention.

One of ordinary skill in the art will appreciate that the apparatus features described herein and illustrated in the FIGS. may be arranged in other than the recited configuration and that one or more of the features may be optional. Also, the methods described herein and illustrated in the FIGS. may be performed in other than the recited order and that one or more steps illustrated may be optional. The above-referenced embodiments may involve the use of other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for implementing a small business intelligence tool have been provided. Persons skilled in the art will appreciate that the present invention can be practiced by other than the described embodiments, which are presented for purposes of illustration rather than of limitation.

What is claimed is:

1. A method for electronically displaying an indication of customer spending associated with a pre-determined business location, the method comprising:
using a receiver to receive an electronic request, the request authorizing retrieval of customer spend information associated with the location, the customer spend information being based on customer credit, debit and/or check transactions, the customer spend information comprising a plurality of customer spend data points;
using the receiver to receive the customer spend information;
using the receiver to receive an electronic selection of a limitation of the distance from the pre-determined business location, the limitation for limiting the retrieval of customer spend information to a radius corresponding to the limitation; and
using a processor to display a plurality of visual indicators corresponding to the customer spend information, each of the visual indicators being located at a predetermined distance from the actual location of the customer associated with the customer spend data point.

2. The method of claim 1, wherein each of the customer spend data points corresponds to a threshold value of customer data spend.

3. The method of claim 1, further comprising using the processor to display a user-definable overlay is selectable such that a portion of the user-definable overlay circumscribes at least a portion of the customer spend data points.

4. The method of claim 3, further comprising using the processor to determine the density of the value of customers' transactions in a predetermined area using the following equation:
density_{customers}−v(w_{customers})/area (in square miles) circumscribed by overlay
where:
v(w_{customers})=value of customers' transactions.

5. The method of claim 3, further comprising using the processor to determine the density of the value of competition's customers' transactions in a predetermined area using the following equation:
density_{competition's customers}=v(w_{cc})/area (in square miles) circumscribed by overlay;
where:
v(w_{cc})=value of competition's customer's transactions.

6. The method of claim 3, further comprising using the processor to determine the density of the value of all relevant transactions in a predetermined area using the following equation:
densityₐₗₗ=v(wₐₗₗ)/area (in square miles) circumscribed by window;
where:
v(wₐₗₗ)=value of all relevant transactions.

7. The method of claim 1, wherein the customer spend information comprises customer spend information corresponding to customer transactions that occurred over a pre-determined time window.

8. The method of claim 8, further comprising providing a user-selectable interface for determining the pre-determined time window.

9. The method of claim 1, further comprising using the processor to determine the total extrapolated customer spend, as follows:
total extrapolated customer spend=ccsd/% mscc*% cbo
Where:
ccsd=credit card spend data
% mscc=percent market share of particular credit card; and
% cbo=percent of customer base that opt-in to share data.

10. A method for electronically displaying an indication of competitor spending associated with a pre-determined business location, the method comprising:
using a receiver to receive an electronic request, the request authorizing retrieval of customer spend information associated with the location, the competitor spend information being based on competitor credit, debit and/or check transactions, the competitor spend information comprising a plurality of competitor spend data points;
using the receiver to receive the competitor spend information; and
using a processor to display a plurality of visual indicators corresponding to the competitor spend information, each of the visual indicators corresponding to a threshold amount of competitor spend data points located in an area within a pre-defined distance of the visual indicator.

11. The method of claim 10, wherein each of the competitor spend data points corresponds to a threshold value of competitor data spend.

12. The method of claim 10, further comprising using the processor to display a user-definable overlay is selectable such that a portion of the user-definable overlay circumscribes at least a portion of the competitor spend data points.

13. The method of claim 12, further comprising using the processor to determine the density of the value of competition's customers' transactions in a predetermined area using the following equation:
density_{competition's customers}=v(w_{cc})/area (in square miles) circumscribed by overlay;
where:
v(w_{cc})=value of competition's customer's transactions.

14. The method of claim 12, further comprising using the processor to determine the density of the value of all relevant transactions in a predetermined area using the following equation:
densityₐₗₗ=v(wₐₗₗ)/area (in square miles) circumscribed by window;
where:
v(wₐₗₗ)=value of all relevant transactions.

15. The method of claim 10, wherein the competitor spend information comprises competitor spend information corresponding to competitor transactions that occurred over a pre-determined time window.

16. The method of claim 17, further comprising providing a user-selectable interface for determining the pre-determined time window.

17. The method of claim 10, further comprising using the processor to determine the total extrapolated competitor spend, as follows:
total extrapolated competitor spend=ccsd/% mscc*% cbo
where:
ccsd=credit card spend data
% mscc=percent market share of particular credit card; and
% cbo=percent of competitor customer base that opt-in to share data.

18. A method for electronically displaying an indication of customer spending associated with a pre-determined business entity, the customer spending comprising customer spend information, the customer spend information being based on customer credit, debit and/or check transactions, the customer spend information comprising a plurality of customer spend data points, the method comprising:
using the receiver to receive the customer spend information; and
using a processor to display a plurality of visual indicators corresponding to the customer spend information, each of the visual indicators being located at a predetermined distance from the actual location of the customer associated with the customer spend data point.

19. A method for electronically displaying an indication of customer spending associated with a pre-determined business location, the method comprising:
using a receiver to receive an electronic request, the request authorizing retrieval of customer spend information associated with the location, the customer spend information being based on customer credit, debit and/or check transactions, the customer spend information comprising a plurality of customer spend data points;
using the receiver to receive the customer spend information; and
using the receiver to receive an electronic selection of a limitation of the distance from the pre-determined business location, the limitation for limiting the retrieval of customer spend information to a radius corresponding to the limitation; and
using a processor to display a plurality of visual indicators corresponding to the customer spend information.
